(19) United States
(12) Patent Application Publication
(10) Pub. No.: US 2017/0162924 A1
(43) Pub. Date: Jun. 8, 2017

(54) METHOD FOR CONTROLLING EMERGENCY DRIVING OF FUEL CELL VEHICLE AND APPARATUS FOR THE SAME

(71) Applicant: HYUNDAI MOTOR COMPANY, Seoul (KR)

(72) Inventor: Sung Gone YOON, Suwon-si (KR)

(21) Appl. No.: 15/092,954

(22) Filed: Apr. 7, 2016

(30) Foreign Application Priority Data
Dec. 2, 2015 (KR) 10-2015-0170992

(51) Int. Cl. H01M 16/00; H01M 8/04746; H01M 8/04223; H01M 8/04228; B60L 3/00; H01M 8/04089; H01M 8/04029; H01M 10/48; H02J 7/00; B60L 11/18; H01M 8/04537; H01M 8/04955

(52) U.S. Cl. CPC H01M 16/006; H01M 8/04559; H01M 8/04753; H01M 8/04231; H01M 8/04228; H01M 8/04955; H01M 8/04097; H01M 8/04029; H01M 10/48; H02J 7/0052; B60L 11/1887; B60L 11/1883; B60L 3/0053; H01M 2220/20; H01M 2250/20; H02J 2007/0059; B60L 2240/547

(57) ABSTRACT

A method for controlling emergency driving of a fuel cell vehicle, in which a motor is used as a main driving source, includes, by a controller, determining whether a stack voltage monitoring (SVM) apparatus for measuring a stack voltage of a fuel cell is in a failure state; estimating a voltage of the fuel cell using a DC/DC converter which is connected to a high voltage battery when the SVM apparatus is in the failure state; and performing the emergency driving by controlling at least one of the amount of air supply to the fuel cell and the number of hydrogen purge when the estimated voltage is a threshold voltage value.

### CROSS-REFERENCE TO RELATED APPLICATION

This application claims the benefit of priority to Korean Patent Application No. 10-2015-0170992 filed in the Korean Intellectual Property Office on Dec. 2, 2015, the entire content of which is incorporated herein by reference.

### TECHNICAL FIELD

The present disclosure relates to a method for controlling emergency driving of a fuel cell vehicle, and an apparatus for the same.

### BACKGROUND

A fuel cell system has been used in a vehicle as an environment-friendly future vehicle. Such a fuel cell system includes: a fuel cell stack that generates electrical energy with an electrochemical reaction of a reaction gas; a hydrogen supply device that supplies hydrogen, which is fuel, to the fuel cell stack; an air supply device that supplies air including oxygen, which is an oxidizing agent necessary for an electrochemical reaction to the fuel cell stack; a heat and water management system that controls an operation temperature of the fuel cell stack by discharging heat which is a by-product of an electrochemical reaction of the fuel cell stack to outside and that performs a water management function; and a fuel cell system control unit that controls entire operations of the fuel cell system.

In a vehicle equipped with the fuel cell system, when only a fuel cell is used as a power source, the fuel cell is responsible for all loads of constituent elements constituting the vehicle, thus deteriorating performance in an operating area in which efficiency of the fuel cell is low.

Further, when a sudden load is applied to the vehicle, power is not fully supplied to a driving motor and thus performance of the vehicle may be deteriorated because the fuel cell may have a problem due to a sudden load change when electricity is generated by a chemical reaction.

In addition, when the vehicle brakes without a separate power storage, energy from a driving motor cannot be recovered and thus efficiency of a vehicle system is deteriorated because the fuel cell has one-directional output characteristics.

Accordingly, a fuel cell hybrid vehicle has been developed for solving the above problems.

The fuel cell hybrid vehicle has a power storage means, for example, a super capacitor (super cap) or a high voltage battery, that can be charged and discharged as a separate auxiliary power source for providing power necessary for driving a load such as a driving motor in addition to a fuel cell, which is a main power source in a large-sized vehicle such as a bus as well as a small-sized vehicle.

When a stack voltage monitoring (SVM) apparatus for measuring a stack voltage of the fuel cell is in a failure state, the fuel cell hybrid vehicle shuts down the fuel cell system and drives only by a high voltage battery.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a method for controlling emergency driving of a fuel cell vehicle having advantages of performing emergency driving without stopping a fuel cell system when a stack voltage of a fuel cell cannot be measured, and an apparatus for the same.

Accordingly to an exemplary embodiment in the present disclosure, a method for controlling emergency driving of a fuel cell vehicle, which has a motor as a driving source, includes: determining, by a controller, whether a stack voltage monitoring (SVM) apparatus for measuring a stack voltage of a fuel cell is in a failure state; estimating, by the controller, a voltage of the fuel cell by using a DC/DC converter connected to a high voltage battery when the SVM apparatus is in the failure state; and performing, by the controller, the emergency driving by controlling at least one of the amount of air supply to the fuel cell and the number of hydrogen purge when the estimated voltage is a threshold voltage value.

The method may further include stopping an operation of the fuel cell and driving the motor only by the high voltage battery when the estimated voltage is less than the threshold voltage value.

The method may further include stopping an output of the high voltage battery when a state of charge (SOC) of the high voltage battery is less than a threshold SOC value.

The step of determining may include determining, by the controller, that the stack voltage monitoring apparatus is in the failure state when the stack voltage is not received from the stack voltage monitoring apparatus.

The step of estimating the voltage of the fuel cell may estimate an output voltage of the fuel cell based on a voltage of the DC/DC converter.

The step of estimating the voltage of the fuel ell may decrease the voltage of the DC/DC converter when a stack current is not detected from the fuel cell, and estimate the output voltage of the fuel cell by using the voltage of the DC/DC converter when the stack current is detected by synchronizing the voltage of the DC/DC converter with the output voltage of the fuel cell.

The step of performing the emergency driving may include controlling the amount of air supply to the fuel cell so that relative humidity of an air electrode outlet of the fuel cell is reduced.

The step of controlling the amount of air supply may include adjusting the amount of air supply to the fuel cell so that relative humidity at the emergency driving is lower than relative humidity in normal driving.

The step of performing the emergency driving may include adjusting a hydrogen recirculation amount of the fuel cell by increasing the hydrogen purge number.

The step of adjusting the hydrogen recirculation amount may control the number of hydrogen purge by using a purge valve.

According to another exemplary embodiment in the present disclosure, an apparatus for controlling emergency driving of a fuel cell vehicle in which a motor is a main driving source, comprises: a fuel cell; a stack voltage monitoring (SVM) apparatus configured to measure a stack voltage of the fuel cell; and a controller configured to receive the stack voltage of the fuel cell from the SVM and to control the amount of air supply to the fuel cell by controlling an air blower and a humidifier.

According to the present disclosure, by estimating the voltage of the fuel cell by using the DC/DC converter and controlling the emergency driving by controlling the amount of air supply to the fuel cell when the stack voltage monitoring apparatus is in the failure state, it is possible to improve safety and running performance and prevent stack degradation of the fuel cell and a flooding phenomenon.

### BRIEF DESCRIPTION OF THE DRAWINGS

FIG. 1 is a diagram showing an apparatus for controlling emergency driving of a fuel cell vehicle according to an exemplary embodiment in the present disclosure.

FIG. 2 is a flowchart showing a process of controlling emergency driving of a fuel cell vehicle according to an exemplary embodiment in the present disclosure when a stack voltage monitoring apparatus is in a failure state.

FIG. 3 is a diagram showing an example of estimating an output voltage of a fuel cell by an apparatus for controlling emergency driving of a fuel cell vehicle according to an exemplary embodiment in the present disclosure.

FIG. 4 is a diagram showing an example of operation ranges according to relative humidity of an air electrode outlet according to an exemplary embodiment in the present disclosure.

### DETAILED DESCRIPTION OF THE EMBODIMENTS

In the following detailed description, only certain exemplary embodiments in the present disclosure have been shown and described, simply by way of illustration. As those skilled in the art would realize, the described embodiments may be modified in various different ways, all without departing from the spirit or scope of the present disclosure.

Throughout the specification, unless explicitly described to the contrary, the word “comprise” and variations such as “comprises” or “comprising” will be understood to imply the inclusion of stated elements but not the exclusion of any other elements.

Parts indicated by like reference numerals are the same components throughout the specification.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e,g., fuel derived from resources other than petroleum).

In addition, some methods may be executed by at least one controller. The term “controller” refers to a hardware device including a memory and a processor configured to execute one or more steps interpreted as an algorithm structure. The memory stores algorithm steps, and the processor specifically executes the algorithm steps to perform one or more processes to be described below.

Further, control logic of the present disclosure may be implemented by a non-transitory computer-readable medium on a computer-readable means including executable program instructions executed by a processor, a controller, or the like. Examples of a non-transitory computer-readable medium, although not restrictive, include ROMs, RAMs, CD-ROMs, magnetic tapes, floppy disks, flash drives, smart cards, and optical data storages. The computer-readable recording medium may be distributed in a network-connected computer system, and for example, may be stored and executed in a distributed manner by a telematics server or Controller Area Network (CAN).

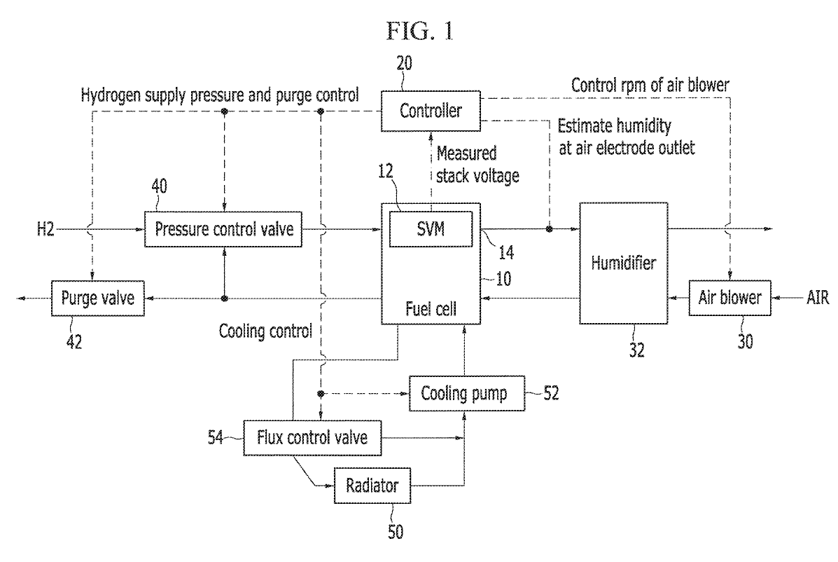

A method for controlling emergency driving of a fuel cell vehicle will now be described with reference to FIG. 1 to FIG. 6.

FIG. 1 is a diagram showing an apparatus for controlling emergency driving of a fuel cell vehicle according to an exemplary embodiment in the present disclosure. In this case, for convenience of explanation, a configuration of the fuel cell vehicle is schematically illustrated, but the fuel cell vehicle is not limited thereto.

As shown in FIG. 1, an apparatus for controlling emergency driving of a fuel cell vehicle according to an exemplary embodiment in the present disclosure includes a fuel cell 10, a controller 20, an air blower 30, a humidifier 32, a pressure control valve 40, a purge valve 42, a radiator 50, a cooling pump 52, and a flux control valve 54.

Referring to FIG. 1, the apparatus for controlling emergency driving of a fuel cell vehicle according to the present disclosure controls the amount of air supply to the fuel cell 10, a hydrogen supply pressure, a purge valve, and a coolant supply line. Herein, the controller 20 receives the stack voltage of the fuel cell 10 from a stack voltage monitoring (SVM) apparatus 12 for measuring a stack voltage of the fuel cell 10. The controller 20 estimates humidity at an air electrode outlet 14 of the fuel cell 10.

In addition, the controller 20 controls the amount of air supply to the fuel cell 10 by controlling the air blower 30 and the humidifier 32 that supplies air to the fuel cell 10. The controller 20 controls the hydrogen supply pressure and purge by controlling the pressure control valve 40 and the purge valve 42. The controller 20 controls the amount of coolant supply to the fuel cell 10 through the radiator 50, the cooling pump 52, and the flux control valve 54.

Here, the controller 20 may be realized by one or more processors activated by a predetermined program, and the predetermined program may be programmed to perform each step of a method for controlling emergency driving of the fuel cell vehicle according to the present disclosure.

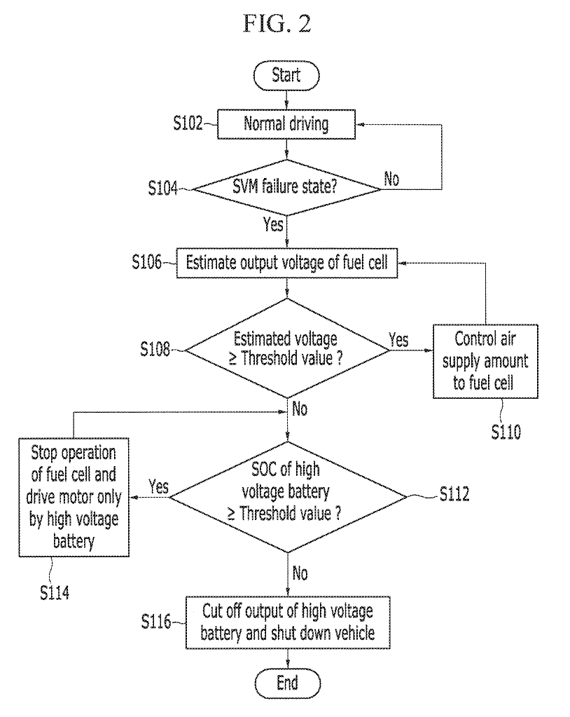

FIG. 2 is a flowchart showing a process of controlling emergency driving of a fuel cell vehicle according to an exemplary embodiment in the present disclosure when a SVM apparatus is in a failure state. The following flowchart will be described with the same reference numerals as those of the configuration of FIG. 1.

Referring to FIG. 2, whether the SVM apparatus 12 is in a failure state is checked during normal driving of the fuel cell vehicle at steps S102 and S104.

The apparatus for controlling emergency driving of a fuel cell vehicle according to the present disclosure estimates an output voltage of the fuel cell 10 by using a DC/DC converter connected to a high voltage battery when the SVM apparatus 12 is in the failure state at step S106. Herein, the controller 20 determines that the SVM apparatus 12 is in the failure state when the stack voltage of the fuel cell 10 is not received from the SVM apparatus 12.

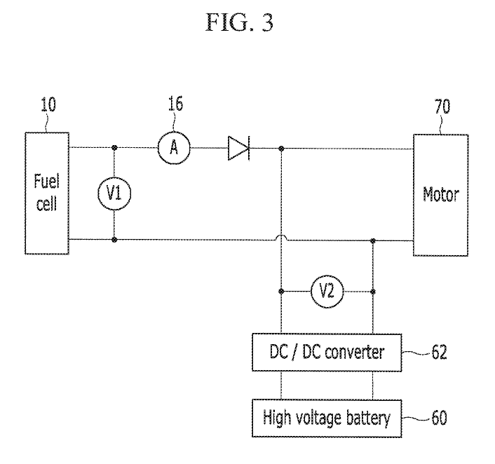

FIG. 3 is a diagram showing an example of estimating an output voltage of a fuel cell by an apparatus for controlling emergency driving of a fuel cell vehicle according to an exemplary embodiment in the present disclosure.

Referring to FIG. 3, the apparatus for controlling emergency driving of a fuel cell vehicle according to an exemplary embodiment in the present disclosure further includes a high voltage battery 60, a DC/DC converter 62, and a motor 70. The DC/DC converter 62 boosts an output of the high voltage battery 60 to a high voltage and supplies the boosted high voltage to the motor 70.

The apparatus for controlling emergency driving of a fuel cell vehicle according the present discloser estimates an output of the fuel cell 10 by using the DC/DC converter 62 when the SVM apparatus 12 is in the failure state. When output voltage V1 of the fuel cell 10 is greater than voltage V2 of the DC/DC converter 62, the apparatus for controlling emergency driving of a fuel cell vehicle estimates output voltage V1 of fuel cell 10 based on measured voltage V2 of the DC/DC converter 62.

However, if stack current 16 is not detected at the fuel cell 10 and output voltage V1 of the fuel cell 10 is lower than measured voltage V2 of the DC/DC converter 62, output voltage V1 of the fuel cell 10 cannot be estimated based on measured voltage V2 of the DC/DC converter 62. Therefore, when stack current 16 is not detected at the fuel cell 10, the apparatus for controlling emergency driving of a fuel cell vehicle decreases the voltage of the DC/DC converter 62 and synchronizes voltage V2 of the DC/DC converter 62 to output voltage V1 of the fuel cell 10. The apparatus for controlling emergency driving of a fuel cell vehicle estimates the output voltage of the fuel cell 10 based on the synchronized voltage of the DC/DC converter 62 when stack current 16 is detected at the fuel cell 10.

The apparatus for controlling emergency driving of a fuel cell vehicle compares an estimated voltage of the fuel cell 10 with a threshold voltage value at step S108.

When the estimated voltage is greater than the threshold voltage value, the apparatus for controlling emergency driving of a fuel cell vehicle controls the amount of air supply to the fuel cell 10 or the number of hydrogen purge and controls emergency driving of the fuel cell vehicle at step S116. When the estimated voltage is less than the threshold voltage value, the apparatus for controlling emergency driving of a fuel cell vehicle stops the operation of the fuel cell 10 and drives the motor 70 only by the high voltage battery 60.

Here, an output capacity of the fuel cell 10 is set to be lower than that in a normal state. The apparatus for controlling emergency driving of a fuel cell vehicle controls the amount of air supply so that relative humidity during emergency driving is lower than that during normal driving. Further, the apparatus for controlling emergency driving of a fuel cell vehicle prevents a cell voltage drop due to flooding through driving in a dry region.

The apparatus for controlling emergency driving of a fuel cell vehicle prevents the flooding by increasing the amount of hydrogen recirculation at an anode by increasing the number of hydrogen purge compared to the normal driving base in a current integral method. The apparatus for controlling emergency driving of a fuel cell vehicle controls the number of hydrogen purge using the purge valve 42.

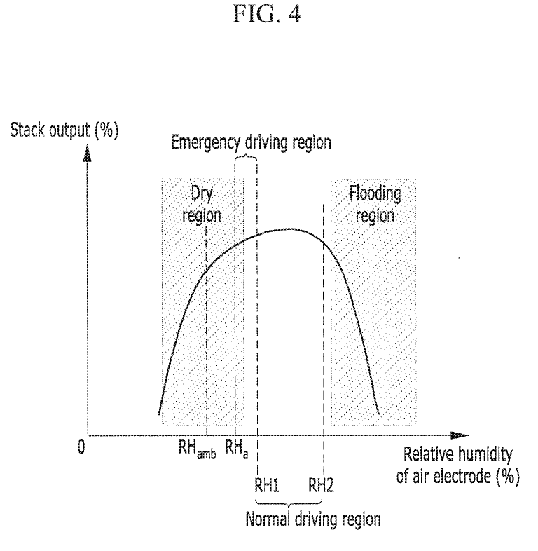

FIG. 4 is a diagram showing operation ranges according to relative humidity of an air electrode outlet according to the present disclosure.

Referring to FIG. 4, the emergency driving control apparatus according to the present disclosure controls so that relative humidity in the emergency driving is lower than relative humidity in normal driving. For example, the emergency driving control apparatus according to the present disclosure controls the amount of air supply to the fuel cell 10 so that relative humidity of the air electrode outlet 14 of the fuel cell 10 decreases.

The relative humidity of the air electrode outlet 14 in an emergency driving region (RHₐ to RH1) is lower than that in a normal driving region (RH1 to RH2), and close to the dry region including atmospheric humidity (RH_{amb}).

Since each stack voltage is not detected when the SVM apparatus 12 is in the failure state, a cell voltage drop due to entering a flooding region cannot be detected. Accordingly, the emergency driving control apparatus according to the present disclosure controls in a dry state around the relative humidity (RH1) of the normal driving region, and prevents flooding phenomenon.

The apparatus for controlling emergency driving of a fuel cell vehicle according to the present disclosure compares a state of charge (SOC) of the high voltage battery 60 with a threshold SOC value at step S112.

The apparatus for controlling emergency driving of a fuel cell vehicle according to the present disclosure stops the operation of the fuel cell 10 and drives the motor 70 only by the high voltage battery 60 when the SOC of the high voltage battery 60 is larger than the threshold SOC value at step S114.

The apparatus for controlling emergency driving of a fuel cell vehicle according to the present disclosure cuts off the output of the high voltage battery 60 when the SOC of the high voltage battery 60 is less than the threshold SOC value at step S116.

As described above, the method for controlling the emergency driving of the fuel cell vehicle according to the present disclosure estimates the voltage of the fuel cell by using the DC/DC converter and controls the emergency driving by controlling the air supply amount to the fuel cell when the stack voltage monitoring apparatus is in the failure state. Therefore, it is possible to improve safety and running performance, and prevent stack degradation of the fuel cell and a flooding phenomenon.

The foregoing exemplary embodiments are not implemented only by an apparatus and a method, and therefore, may be realized by programs realizing functions corresponding to the configuration of the exemplary embodiments or recording media on which the programs are recorded.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A method for controlling emergency driving of a fuel cell vehicle in which a motor is a main driving source, the method comprising:
determining, by a controller, whether a stack voltage monitoring (SVM) apparatus for measuring a stack voltage of a fuel cell is in a failure state;
estimating, by the controller, a voltage of the fuel cell by using a DC/DC converter which is connected to a high voltage battery when the SVM apparatus is in the failure state: and
performing, by the controller, the emergency driving by controlling at least one of the amount of air supply to the fuel cell and the number of hydrogen purge when the estimated voltage is a threshold voltage value or more.

2. The method of claim 1, further comprising:
stopping an operation of the fuel cell and driving the motor only by the high voltage battery when the estimated voltage is less than the threshold voltage value.

3. The method of claim 2, further comprising:
stopping an output of the high voltage battery when a state of charge (SOC) of the high voltage battery is less than a threshold SOC value.

4. The method of claim 3, wherein the step of determining includes determining that the SVM apparatus is in the failure state when the stack voltage is not received from the SVM apparatus.

5. The method of claim 3, wherein the step of estimating the voltage of the fuel cell estimates an output voltage of the fuel cell based on a voltage of the DC/DC converter.

6. The method of claim 5, wherein the step of estimating the voltage of the fuel cell decreases the voltage of the DC/DC converter when a stack current is not detected from the fuel cell and estimates the output voltage of the fuel cell at the voltage of the DC/DC converter when the stack current is detected by synchronizing the voltage of the DC/DC converter with the output voltage of the fuel cell.

7. The method of claim 3, wherein the step of performing the emergency driving includes controlling the amount of air supply to the fuel cell to decrease relative humidity at an air electrode outlet of the fuel cell.

8. The method of claim 7, wherein the step of controlling the amount of air supply includes adjusting the amount of air supply to the fuel cell so that relative humidity during the emergency driving is lower than that during normal driving.

9. The method of claim 3, wherein the step of performing the emergency driving includes adjusting the amount of hydrogen recirculation of the fuel cell by increasing the number of hydrogen purge.

10. The method of claim 9, wherein the step of adjusting the amount of hydrogen recirculation controls the number of hydrogen purge using a purge valve.

11. An apparatus for controlling emergency driving of a fuel cell vehicle in which a motor is a main driving source, the apparatus comprising:
a fuel cell;
a stack voltage monitoring (SVM) apparatus configured to measure a stack voltage of the fuel cell; and
a controller configured to receive the stack voltage of the fuel cell from the SVM and to control the amount of air supply to the fuel cell by controlling an air blower and a humidifier.

12. The apparatus of claim 11, wherein the controller controls the hydrogen supply pressure and purge by controlling the pressure control valve and the purge valve and estimates humidity at an air electrode outlet of the fuel cell.

13. The apparatus of claim 11, wherein the controller further controls hydrogen supply pressure and the number of hydrogen purge by controlling a pressure control valve and a purge valve, respectively.

14. The apparatus of claim 11, wherein the controller further controls the amount of coolant supply to the fuel cell through a radiator, a cooling pump, and a flux control valve.

15. The apparatus of claim 11, further comprising:
a high voltage battery; and
a DC/DC converter configured to boost an output of the high voltage battery to a high voltage and to supply the boosted high voltage to the motor.

16. The apparatus of claim 15, wherein the controller estimates a voltage of the fuel cell by using the DC/DC converter when the SVM apparatus is in a failure state.
